(19) United States
(12) Patent Application Publication
(10) Pub. No.: US 2026/0027574 A1
(43) Pub. Date: Jan. 29, 2026

(54) Aggregate Adhesive Delivery Assemblies and Methods of Delivering Adhesive onto Aggregate

(71) Applicants: Britt Babcock, Houston, TX (US); Roger Borremans, Canyon Lake, TX (US); Jacob Swanson, Burnsville, MN (US); Nikolas Magill, Houston, TX (US); Anthony Covey, Texas City, TX (US)

(72) Inventors: Britt Babcock, Houston, TX (US); Roger Borremans, Canyon Lake, TX (US); Jacob Swanson, Burnsville, MN (US); Nikolas Magill, Houston, TX (US); Anthony Covey, Texas City, TX (US)

(21) Appl. No.: 19/282,744

(22) Filed: Jul. 28, 2025

Related U.S. Application Data
(60) Provisional application No. 63/676,219, filed on Jul. 26, 2024.

(51) Int. Cl. B05B 9/043; B05B 13/00

(52) U.S. Cl. CPC B05B 9/043; B05B 13/005

(57) ABSTRACT

Disclosed herein are methods of delivering adhesive onto aggregate, which methods may include: providing an aggregate adhesive delivery assembly that may include: a vessel; a pump fluidly coupled to the vessel; an inner conduit fluidly coupled to the pump, the inner conduit having one or more inner apertures extending therethrough; and an outer conduit disposed around the inner conduit, the outer conduit having one or more outer apertures extending therethrough; pumping, with the pump, fluid from the vessel into the inner conduit; ejecting the fluid in the inner conduit through the one or more inner apertures in an upward direction into the outer conduit; and causing the fluid in the outer conduit to exit the one or more outer apertures in a downward direction.

### BACKGROUND

### 1. Field of Inventions

The field of this application and any resulting patent is aggregate adhesive delivery assemblies and methods of delivering adhesive onto aggregate.

### 2. Description of Related Art

Various aggregate adhesive delivery assemblies and methods of delivering aggregate adhesive have been proposed and utilized, including some of the assemblies, methods, and structures disclosed in some of the references appearing on the face of this patent. However, those assemblies, methods, and structures lack the combination of steps and/or features of the assemblies, methods, and/or structures disclosed herein. Furthermore, it is contemplated that the methods and/or structures disclosed herein solve many of the problems that prior art assemblies, methods, and structures have failed to solve. Also, the assemblies, methods, and/or structures disclosed herein have benefits that would be surprising and unexpected to a hypothetical person of ordinary skill with knowledge of the prior art existing as of the filing date of this application.

### SUMMARY

Disclosed herein are aggregate adhesive delivery assemblies that may each include: a vessel; a valve fluidly coupled to the vessel, wherein the valve is capable of being turned to an open position or a closed position; a first hose fluidly coupled to the valve; a pump fluidly coupled to the first hose; a second hose fluidly coupled to the pump; an inner conduit fluidly coupled to the second hose and positioned horizontally, the inner conduit may include: an inner cylindrical wall; and one or more inner apertures extending through an upper portion of the inner cylindrical wall; and an outer conduit disposed around the inner conduit and positioned horizontally, the outer conduit may include: an outer cylindrical wall; and one or more outer apertures extending through a lower portion of the outer cylindrical wall.

Additionally, disclosed herein are aggregate adhesive delivery assemblies that may each include: a vessel; a pump fluidly coupled to the vessel; an inner conduit fluidly coupled to the pump and positioned horizontally, the inner conduit may include: an inner cylindrical wall; and one or more inner apertures extending through the inner cylindrical wall, wherein any fluid exiting the one or more inner apertures may flow only in an upward direction; and an outer conduit disposed around the inner conduit and positioned horizontally, the outer conduit may include: an outer cylindrical wall; and one or more outer apertures extending through the outer cylindrical wall and capable of receiving fluid exiting the one or more inner apertures, wherein any fluid exiting the one or more outer apertures may flow only in a downward direction.

Also, disclosed herein is a method of delivering adhesive onto aggregate, which method includes: providing an aggregate adhesive delivery assembly that may include: a vessel; a pump fluidly coupled to the vessel; an inner conduit fluidly coupled to the pump, the inner conduit having one or more inner apertures extending therethrough; and an outer conduit disposed around the inner conduit, the outer conduit having one or more outer apertures extending therethrough; pumping, with the pump, fluid from the vessel into the inner conduit; ejecting the fluid in the inner conduit through the one or more inner apertures in an upward direction into the outer conduit; and causing the fluid in the outer conduit to exit the one or more outer apertures in a downward direction.

In addition, disclosed herein is a method of delivering adhesive onto aggregate, which method includes: providing an aggregate adhesive delivery assembly that may include: a vessel; a pump fluidly coupled to the vessel; an inner conduit having one or more inner apertures extending therethrough; and an outer conduit disposed around the inner conduit, the outer conduit having one or more outer apertures extending therethrough; pumping, with the pump, fluid from the vessel into the inner conduit; ejecting the fluid in the inner conduit through the one or more inner apertures into the outer conduit; and causing the fluid in the outer conduit to exit the one or more outer apertures.

Furthermore, disclosed herein is a method of delivering adhesive onto aggregate, which method includes: providing an aggregate adhesive delivery assembly that may include: a vessel; a pump fluidly coupled to the vessel; an inner conduit having one or more inner apertures extending through an upper portion of the inner conduit; and an outer conduit disposed around the inner conduit, the outer conduit having one or more outer apertures extending through a lower portion of the outer conduit; pumping, with the pump, fluid from the vessel into the inner conduit; ejecting the fluid in the inner conduit through the one or more inner apertures into the outer conduit; and causing the fluid in the outer conduit to exit the one or more outer apertures in a downwardly direction.

Moreover, disclosed herein is a method of delivering adhesive onto aggregate, which method includes: providing an aggregate adhesive delivery assembly that may include: a vessel; a pump fluidly coupled to the vessel; an inner conduit having one or more inner apertures extending through a top portion of the inner conduit; and an outer conduit disposed around the inner conduit, the outer conduit having one or more outer apertures extending through a bottom portion of the outer conduit; pumping, with the pump, fluid from the vessel into the inner conduit; ejecting the fluid in the inner conduit through the one or more inner apertures in an upwardly direction into the outer conduit; and causing the fluid in the outer conduit to exit the one or more outer apertures in a downwardly direction.

### BRIEF DESCRIPTION OF THE DRAWINGS

FIG. 1A illustrates an overhead view of an aggregate adhesive delivery assembly.

FIG. 1B illustrates a front profile view of an aggregate adhesive delivery assembly.

FIG. 2A illustrates an exploded view of a boom where an outer conduit and an inner conduit of the boom are depicted as see-through.

FIG. 2B illustrates a cross-sectional view of a boom.

FIG. 3A illustrates a side view of an aggregate adhesive delivery assembly configured for carriage by a skid-steer loader.

FIG. 3B illustrates an overhead view of an aggregate adhesive delivery assembly carried by a skid-steer loader.

FIG. 4 illustrates a side view of an aggregate adhesive delivery assembly configured for coupling to a tractor.

### DETAILED DESCRIPTION

### 1. Introduction

A detailed description will now be provided. The purpose of this detailed description, which includes the drawings, is to satisfy the statutory requirements of 35 U.S.C. § 112. For example, the detailed description includes a description of the inventions disclosed herein and sufficient information that would enable a person having ordinary skill in the art to make and use the inventions. In the figures, like elements are generally indicated by like reference numerals regardless of the view or figure in which the elements appear. The figures are intended to assist with the description and to provide a visual representation of certain aspects of the subject matter described herein. The figures are not all necessarily drawn to scale, nor do they show all the structural details of the systems, nor do they limit the scope of the disclosure herein.

### 2. Selected Definitions

Certain terms, as used herein, are expressly defined below.

The term “adjacent” as used herein means next to and includes physical contact but does not require physical contact.

The term “aggregate” as used herein as a noun means a collection of loose solid objects, e.g., crushed pieces of concrete, asphalt, stones, rocks, sand, gravel, slag, and mulch. An aggregate may be a mixture of various materials, e.g., organic and/or inorganic.

The term “aligning” as used herein is defined as a verb that means manufacturing, forming, adjusting, or arranging one or more physical objects into a particular position. After any aligning takes place, the objects may be fully or partially “aligned.” Aligning preferably involves arranging a structure or surface of a structure in linear relation to another structure or surface; for example, their borders or perimeters may share a set of parallel tangential lines. In certain instances, the aligned borders or perimeters may share a similar profile.

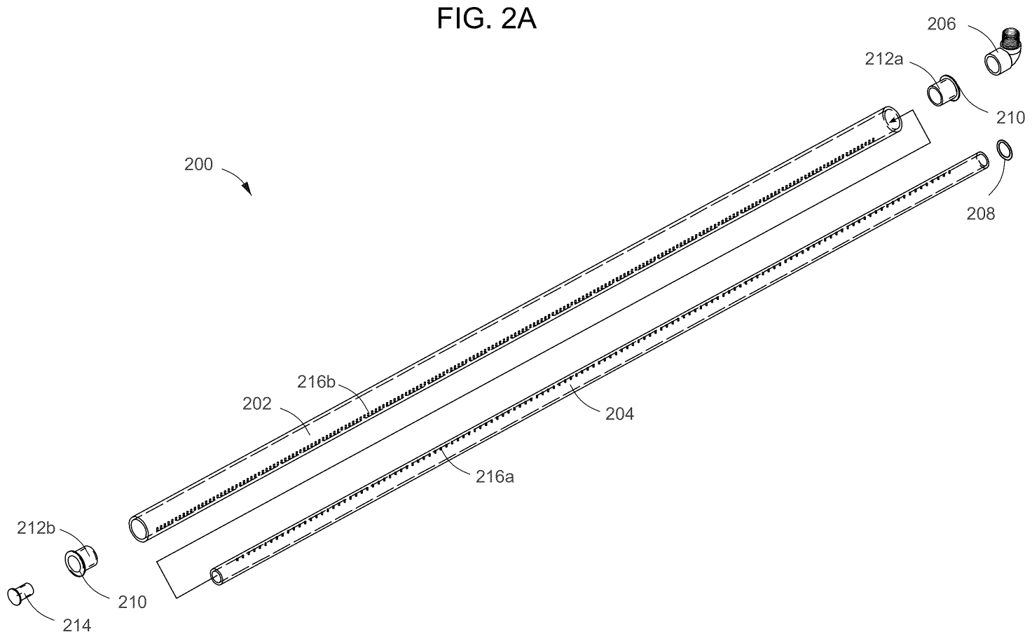

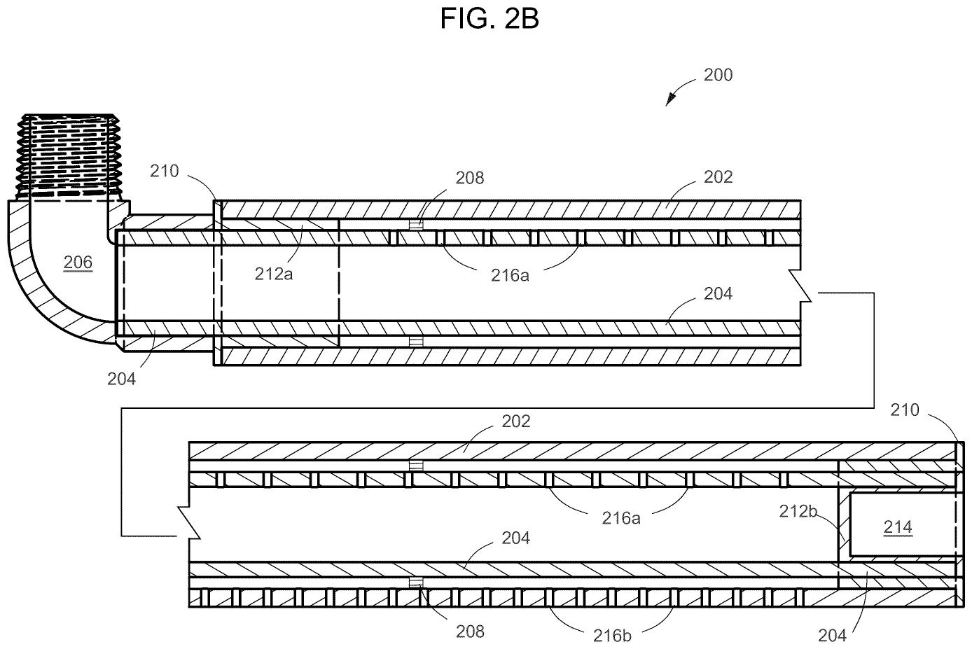

The term “annulus” as used herein is defined as any space having an annular form, e.g., the cylindrical space between the inside surface of the wall of an outer conduit, e.g., the “outer conduit” illustrated in FIG. 2B, and the outside surface of the wall of an inner conduit, e.g., the “inner conduit” illustrated in FIG. 2B.

The term “aperture” as used herein is defined as any opening in a solid object or structure. For example, an aperture may be an opening that begins on one side of the solid object and ends on the other side of the object. An aperture may alternatively be an opening that does not pass entirely through the object, but only partially passes through, e.g., a groove. An aperture can be an opening in an object that is completely circumscribed, defined, or delimited by the object itself. Alternatively, an aperture can be an opening in the object formed when the object is combined with one or more other objects or structures. One or more apertures may be disposed and pass entirely through a conduit, cap, and/or a pump. An aperture may receive fluid and permit ingress and/or egress of the fluid through the aperture. An aperture may have a circular, oval, elliptical, or polygonal cross-section. A polygonal cross-section may be triangular, square, rectangular, pentagonal, hexagonal, or octagonal. An aperture may be elongated, e.g., a slit. For example, an elongated aperture may extend axially, e.g., longitudinally, in a cylindrical wall of a conduit.

The term “assembly” as used herein is defined as any set of components that have been fully or partially assembled together. A group of assemblies may be coupled to form a body having an inner surface and an outer surface. The term “adhesive delivery assembly” as used herein is any assembly that may include a base, a vessel, a pump, a filter, and a boom that may be sized, shaped, and configured to deliver fluid, e.g., adhesive, onto surfaces of beds of material, e.g., substrate, aggregate, asphalt, concrete, sand, pebbles, and rocks.

The term “cap” as used herein as a noun is defined as a structure configured, sized, and shaped to inhibit flow of fluid in a conduit. A cap may be hollow through which fluid may flow. A cap may include a flange. The flange may extend radially from a body of the cap. A cap may be coupled to a conduit. A cap may be inserted into a conduit. A cap may be constructed of elastomeric material, such as silicone or rubber, e.g., fluorocarbon rubber (FKM), nitrile rubber (NBR), hydrogenated nitrile (HNBR), or acrylonitrile butadiene rubber. A cap may be constructed of plastic material, such as PEEK, PTFE, or PE-UHMW. A cap may be constructed of rigid material, e.g., metal, fiber glass, carbon fiber, or PVC.

The term “coupled” as used herein is defined as directly or indirectly connected, attached, or integral with, e.g., part of. A first object may be coupled to a second object such that the first object is positioned at a specific location and orientation with respect to the second object. For example, a plug may be coupled to a cap or a conduit. Two objects may be “removably coupled” to each other via threads, tape, latches, hooks, fasteners, locks, male and female connectors, clips, slip joints, and/or clamps. Thus, a cap may be removably coupled to a conduit such that the cap may then be uncoupled and removed from the conduit. Two objects may be “fluidly coupled,”, e.g., where fluid is capable of flowing between the two objects. For example, a valve may be fluid coupled, e.g., via a hose, to a pump such that fluid may flow from the valve to the pump. Two objects may be “sealingly coupled,” e.g., where a first object may be abutted against a second object such that respective adjacent surfaces of the objects would be inhibited fluid from flowing therebetween. For example, a plug may be sealingly coupled to a fluid conduit, e.g., pipe, hose, or hollow cap, where, in some cases, fluid cannot flow between adjacent surfaces of the plug and fluid conduit.

The term “conduit” as used herein is defined as a structure configured for flow of fluid therethrough. A conduit may have an opening extending from one end of the conduit to a second end of the conduit. A conduit may be cylindrical. A conduit may be referred to as a “hose” and/or a “pipe.” A conduit may have one or more apertures extending through a wall of the conduit. The one or more apertures may extend perpendicular to a central axis of the conduit. A conduit may be constructed from plastic, metal, fiber glass, graphite, or carbon fiber.

The term “cure” as used herein is defined as a process of hardening or setting of materials. Curing may be by chemical reaction in which two materials are mixed to form a mixture that hardens. Curing may be by chemical reaction in which two materials are mixed to form a mixture that moisture cures where moisture, e.g., water, reacts with the material, causing the material to harden. Curing may be by ultraviolet (UV) radiation in which the material contains ingredients capable of initiating a chemical reaction in the material upon exposure to UV radiation, causing the material to harden. Curing may be by evaporation where the material contains volatile ingredients that causes the material to harden upon evaporation of the volatile materials.

The term “cylindrical” as used herein is defined as shaped like a cylinder, e.g., having straight parallel sides and a circular, oval, elliptical, or polygonal cross-section. A polygonal cross-section may be triangular, square, rectangular, pentagonal, hexagonal, or octagonal. A cylindrical body or structure, e.g., pipe, hose, or hollow cap, may be completely or partially shaped like a cylinder. A cylindrical body, e.g., pipe, hose, or hollow cap, which has an outer diameter that changes abruptly may have a radial face or “lip” extending toward the center axis. A cylindrical body may have an aperture that extends through the entire length of the body to form a hollow cylinder that is capable of permitting fluid, e.g., adhesive, to pass through. On the other hand, a cylindrical structure may be solid, e.g., plug.

The term “disposed in” as used herein means having been put, placed, positioned, arranged, inserted, or oriented in a particular location. For example, when an inner conduit occupies a position within an outer conduit, the inner conduit is disposed within the outer conduit.

The terms “first,” “second,” and “third” when used to refer to certain things, e.g., structures, are terms that differentiate those things from one another and do not mean or imply anything in terms of importance, sequence, etc.

The term “flow” as used herein, as a verb, noun, or word that modifies another word, e.g., volume, describes or refers to the moving, or the movement or passage, of a fluid, preferably substantially in a particular direction. For example, reservoir fluid may flow in a downward direction in the interior of a conduit or an annular space. Such flow can be laminar or turbulent, or a combination of laminar and turbulent. Flow volume in that context may be measured in a variety of units, e.g., gallons or liters. Time may be measured in seconds, minutes, hours, or days.

The term “fluid” as used herein is defined as a material that is capable of flowing. A fluid may be a liquid or a gas or some mixture of liquid and gas. A fluid may absorb heat. A fluid has inherent properties which may in certain embodiments are measurable, such as viscosity, anti-foaming, thermal stability, thermal conductivity, and thermal capacity. A fluid may coat the surfaces of an object or structure. A fluid may include adhesive properties and materials, e.g., resins, epoxy, urethane, and cement, that cure when exposed to air. A fluid may include adhesive properties and materials, e.g., resins and epoxy, which harden when cured or dried. The term “adhesive” as used herein is defined as any fluid that can bond two or more surfaces together. An adhesive may form bonds by chemical reaction, molecular forces or through interfacial bonding. An adhesive may cure as thermosetting, thermoplastic, reactive and/or evaporative (water or solvent based). An adhesive may be referred to as glue or resin.

The term “plug” as used herein as a noun is defined as a solid structure configured, sized, and shaped to inhibit flow of fluid through a portion of a hollow cap and/or conduit. A plug may be coupled to a cap. A plug may be inserted into a hollow cap. A plug may be disposed in an aperture of a cap and/or a conduit.

The term “pressure” as used herein means force(s), including but not limited to the forces exerted in every direction an enclosed space, e.g., forces applied against the inside surfaces of any structure defining the enclosed space. Pressure may be, for example, exerted against a surface of an object, e.g., pump and/or conduit. Pressure may also be exerted against a fluid.

The term “providing” as used herein is defined as making available, furnishing, supplying, equipping, or causing to be placed in position.

The term “pump” as used herein as a noun is defined as an assembly capable of driving movement, e.g., flow, of fluid.

The term “row” as used herein as a noun is defined as a series of objects or structures disposed on a line. An object or structure disposed on a line if that object or structure has a portion intersecting the line.

The term “spacer” as used herein is defined as a structure or object configured, sized, and shaped to be disposed between two other structures or objects so that space exists between the two other structures or objects.

The term “surface” as used herein is defined as any boundary of a structure. A surface may also refer to that cylindrical area that extends radially around a cylinder which may, for example, be part of a shaft assembly or bearing assembly. A surface may also refer to that cylindrical area that extends radially around a cylinder which may, for example, be part of a base or a conduit. A “surface” may have any geometry, e.g., curved or flat. A surface may have irregular contours. A surface may be formed from components, e.g., bearing assemblies, bodies, and/or housings, coupled together. Coupled components may form irregular surfaces.

The term “simultaneously” as used herein is defined as at or nearly at the same time. To events may occur simultaneously a first event occurs millisecond, e.g., from 2 ms, 3 ms, 4 ms, or 5 ms to 6 ms, 7 ms, 8 ms, or 9 ms.

The terms “upper,” “lower,” “top,” “bottom” as used herein are relative terms describing the position of one object, thing, or point positioned in its intended useful position, relative to some other object, thing, or point also positioned in its intended useful position, when the objects, things, or points are compared to distance from the center of the earth. For example, the term “upper” identifies any object or part of a particular object that is farther away from the center of the earth than some other object or part of that particular object, when the objects are positioned in their intended useful positions.

The term “vessel” as used herein is defined as any structure configured, sized, and/or shaped to store fluid. A vessel may have one or more apertures through which fluid may enter the vessel and/or exit from inside the vessel. A valve may have a portion inserted through an aperture of a vessels for fluid coupling to the vessel, for which when the valve is in an open configuration fluid may exit the vessel through the valve and when the valve is in closed configuration fluid may be inhibited from exiting the vessel. An aperture of a vessel may be sealingly coupled with or without a cap.

### 3. Certain Specific Embodiments

Disclosed herein are aggregate adhesive delivery assemblies that may each include: a vessel; a valve fluidly coupled to the vessel, wherein the valve is capable of being turned to an open position or a closed position; a first hose fluidly coupled to the valve; a pump fluidly coupled to the first hose; a second hose fluidly coupled to the pump; an inner conduit fluidly coupled to the second hose and positioned horizontally, the inner conduit may include: an inner cylindrical wall; and one or more inner apertures extending through an upper portion of the inner cylindrical wall; and an outer conduit disposed around the inner conduit and positioned horizontally, the outer conduit may include: an outer cylindrical wall; and one or more outer apertures extending through a lower portion of the outer cylindrical wall.

Additionally, disclosed herein are aggregate adhesive delivery assemblies that may each include: a vessel; a pump fluidly coupled to the vessel; an inner conduit fluidly coupled to the pump and positioned horizontally, the inner conduit may include: an inner cylindrical wall; and one or more inner apertures extending through the inner cylindrical wall, wherein any fluid exiting the one or more inner apertures may flow only in an upward direction; and an outer conduit disposed around the inner conduit and positioned horizontally, the outer conduit may include: an outer cylindrical wall; and one or more outer apertures extending through the outer cylindrical wall and capable of receiving fluid exiting the one or more inner apertures, wherein any fluid exiting the one or more outer apertures may flow only in a downward direction.

Also, disclosed herein is a method of delivering adhesive onto aggregate, which method includes: providing an aggregate adhesive delivery assembly that may include: a vessel; a pump fluidly coupled to the vessel; an inner conduit fluidly coupled to the pump, the inner conduit having one or more inner apertures extending therethrough; and an outer conduit disposed around the inner conduit, the outer conduit having one or more outer apertures extending therethrough; pumping, with the pump, fluid from the vessel into the inner conduit; ejecting the fluid in the inner conduit through the one or more inner apertures in an upward direction into the outer conduit; and causing the fluid in the outer conduit to exit the one or more outer apertures in a downward direction.

In addition, disclosed herein is a method of delivering adhesive onto aggregate, which method includes: providing an aggregate adhesive delivery assembly that may include: a vessel; a pump fluidly coupled to the vessel; an inner conduit having one or more inner apertures extending therethrough; and an outer conduit disposed around the inner conduit, the outer conduit having one or more outer apertures extending therethrough; pumping, with the pump, fluid from the vessel into the inner conduit; ejecting the fluid in the inner conduit through the one or more inner apertures into the outer conduit; and causing the fluid in the outer conduit to exit the one or more outer apertures.

Furthermore, disclosed herein is a method of delivering adhesive onto aggregate, which method includes: providing an aggregate adhesive delivery assembly that may include: a vessel; a pump fluidly coupled to the vessel; an inner conduit having one or more inner apertures extending through an upper portion of the inner conduit; and an outer conduit disposed around the inner conduit, the outer conduit having one or more outer apertures extending through a lower portion of the outer conduit; pumping, with the pump, fluid from the vessel into the inner conduit; ejecting the fluid in the inner conduit through the one or more inner apertures into the outer conduit; and causing the fluid in the outer conduit to exit the one or more outer apertures in a downwardly direction.

Moreover, disclosed herein is a method of delivering adhesive onto aggregate, which method includes: providing an aggregate adhesive delivery assembly that may include: a vessel; a pump fluidly coupled to the vessel; an inner conduit having one or more inner apertures extending through a top portion of the inner conduit; and an outer conduit disposed around the inner conduit, the outer conduit having one or more outer apertures extending through a bottom portion of the outer conduit; pumping, with the pump, fluid from the vessel into the inner conduit; ejecting the fluid in the inner conduit through the one or more inner apertures in an upwardly direction into the outer conduit; and causing the fluid in the outer conduit to exit the one or more outer apertures in a downwardly direction.

In any one of the methods or structures disclosed herein, any fluid exiting the one or more inner apertures may flow only in an upward direction.

In any one of the methods or structures disclosed herein, any fluid exiting the one or more outer apertures may flow only in a downward direction.

Any one of the methods or structures disclosed herein may further include a spacer disposed between the inner conduit and the outer conduit.

Any one of the methods or structures disclosed herein may further include a filter coupled to a pump.

Any one of the methods or structures disclosed herein may further include a joint coupled to the pump and the inner conduit.

Any one of the methods or structures disclosed herein may further include a first cap coupled to a first end of the outer conduit, wherein a portion of the first cap inhibits fluid may flow out of the first end.

Any one of the methods or structures disclosed herein may further include a first cap coupled to a first end of the inner conduit, wherein fluid is capable of flowing through the cap and the first end.

Any one of the methods or structures disclosed herein may further include a second cap coupled to a second end of the outer conduit, wherein a portion of the second cap may inhibit fluid flow out of the second end.

Any one of the methods or structures disclosed herein may further include a second cap coupled to a second end of the inner conduit, wherein fluid is capable of flowing through the cap and the second end.

Any one of the methods or structures disclosed herein may further include a plug coupled to a second end of the inner conduit, wherein the plug inhibits fluid may flow out of the second end.

In any one of the methods or structures disclosed herein, the inner conduit may be parallel to the base.

In any one of the methods or structures disclosed herein, the outer conduit may be parallel to the base.

In any one of the methods or structures disclosed herein, the outer conduit is capable of receiving fluid exiting from the one or more inner apertures.

In any one of the methods or structures disclosed herein, the one or more outer apertures may be capable of receiving fluid exiting from the one or more inner apertures.

In any one of the methods or structures disclosed herein, the one or more inner apertures may extend through an upper portion of the inner cylindrical wall.

In any one of the methods or structures disclosed herein, the one or more outer apertures may extend through a lower portion of the outer cylindrical wall.

Any one of the methods disclosed herein may further include ejecting fluid in the inner conduit through each inner aperture of the one or more inner apertures simultaneously.

Any one of the methods disclosed herein may further include causing fluid in the outer conduit to exit through each outer aperture of the one or more outer apertures simultaneously.

In any one of the methods or structures disclosed herein, fluid flowing through the one or more inner apertures flow in a first direction and fluid flowing through the outer aperture flow in a second direction that may be opposite of the first direction.

In any one of the methods or structures disclosed herein, the one or more inner apertures are aligned in a row.

In any one of the methods or structures disclosed herein, the one or more inner apertures are evenly spaced.

In any one of the methods or structures disclosed herein, the one or more outer apertures are aligned in a row.

In any one of the methods or structures disclosed herein, the one or more outer apertures are evenly spaced.

In any one of the methods or structures disclosed herein, the one or more inner apertures are aligned in a first row and the one or more outer apertures are aligned in a second row parallel to the first row.

In any one of the methods or structures disclosed herein, the one or more inner apertures are aligned in a first row and the one or more outer apertures are aligned in a second row directly below the first row.

In any one of the methods or structures disclosed herein, the upper portion of the inner conduit has a semi-circular inner surface.

In any one of the methods or structures disclosed herein, the lower portion of the outer conduit has a semi-circular inner surface.

In any one of the methods or structures disclosed herein, fluid flowing through the one or more inner apertures flow in an upwardly direction and fluid flowing through the one or more outer aperture flow in a downwardly direction.

In any one of the methods or structures disclosed herein, the one or more inner apertures are disposed above the one or more outer apertures.

In any one of the methods or structures disclosed herein, the one or more inner apertures are disposed above the one or more outer apertures.

In any one of the methods or structures disclosed herein, fluid flowing through the one or more inner apertures flow in a first direction and fluid flowing through the one or more outer apertures flow in a second direction that is opposite of the first direction.

In any one of the methods or structures disclosed herein, the aggregate adhesive delivery assembly may further include a cap having a cap portion abutted against an outer surface of the inner conduit and an inner surface of the outer conduit.

In any one of the methods or structures disclosed herein, the aggregate adhesive delivery assembly may further include a cap having a cap portion disposed between an end the inner conduit and an end of the outer conduit.

In any one of the methods or structures disclosed herein, the aggregate adhesive delivery assembly may further include a cap having a portion capable of inhibiting fluid flow in an annulus that is between the inner conduit and the outer conduit.

In any one of the methods or structures disclosed herein, the aggregate adhesive delivery assembly may further include a cap having a portion disposed within the outer conduit.

In any one of the methods or structures disclosed herein, the aggregate adhesive delivery assembly may further include a cap having a portion of the first conduit disposed therein.

### 4. Specific Embodiments in the Drawings

The drawings presented herein are for illustrative purposes only and do not limit the scope of the claims. Rather, the drawings are intended to help enable one having ordinary skill in the art to make and use the claimed inventions.

This section addresses specific versions of aggregate adhesive delivery assemblies shown in the drawings, which relate to assemblies, elements and parts that can be part of an aggregate adhesive delivery assembly. Although this section focuses on the drawings herein, and the specific embodiments found in those drawings, parts of this section may also have applicability to other embodiments not shown in the drawings. The limitations referenced in this section should not be used to limit the scope of the claims themselves, which have broader applicability.

Although the systems, methods, structures, elements, and parts described herein have been described in detail, it should be understood that various changes, substitutions, and alterations can be made without departing from the spirit and scope of the inventions as defined by the following claims. Those skilled in the art may be able to study the preferred embodiments and identify other ways to practice the inventions that are not exactly as described herein. It is the intent of the inventors that variations and equivalents of the inventions are within the scope of the claims, while the description, abstract and drawings are not to be used to limit the scope of the inventions. The inventions are specifically intended to be as broad as the claims below and their equivalents.

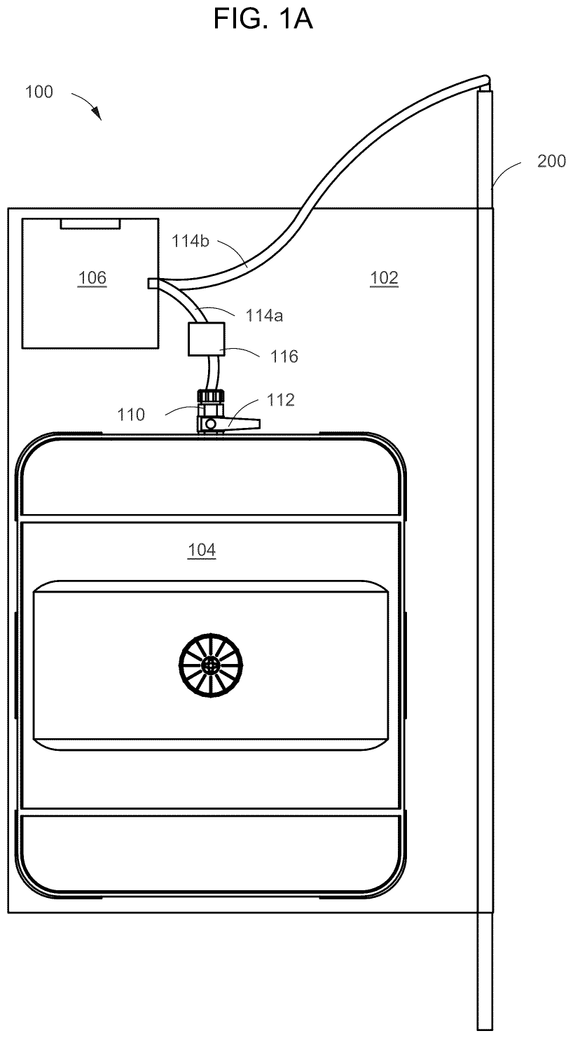

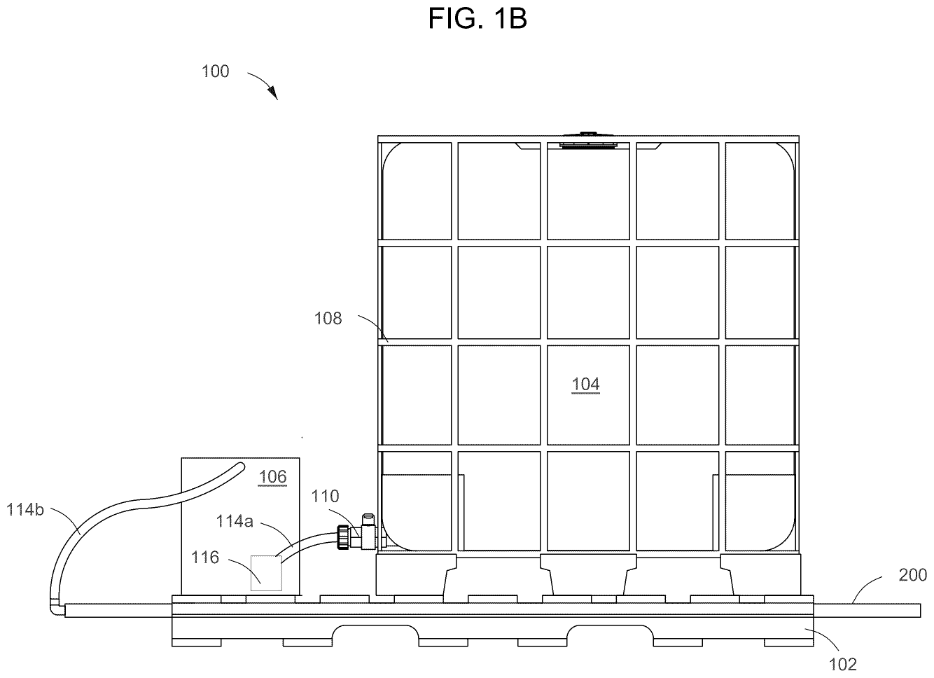

FIG. 1A illustrates an overhead view of an aggregate adhesive delivery assembly 100. FIG. 1B illustrates a front profile view of an aggregate adhesive delivery assembly 100.

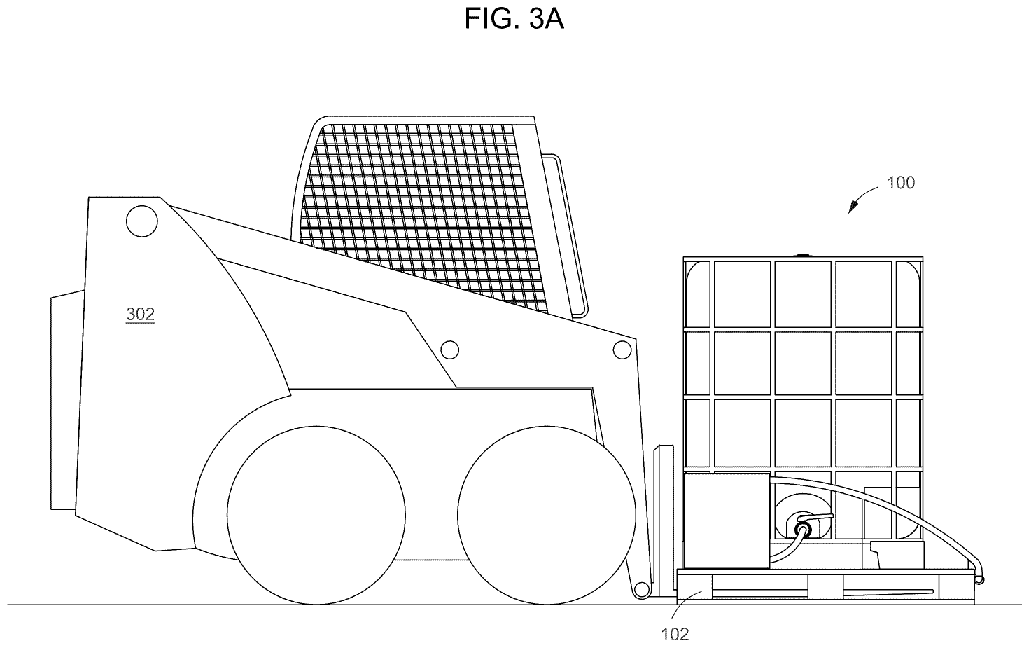

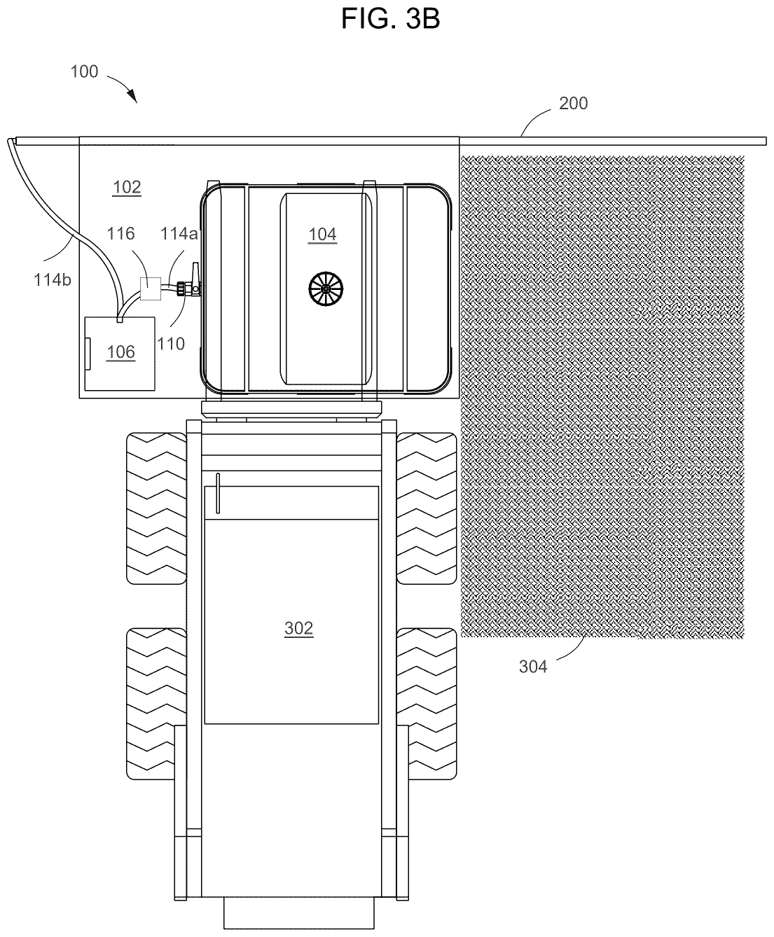

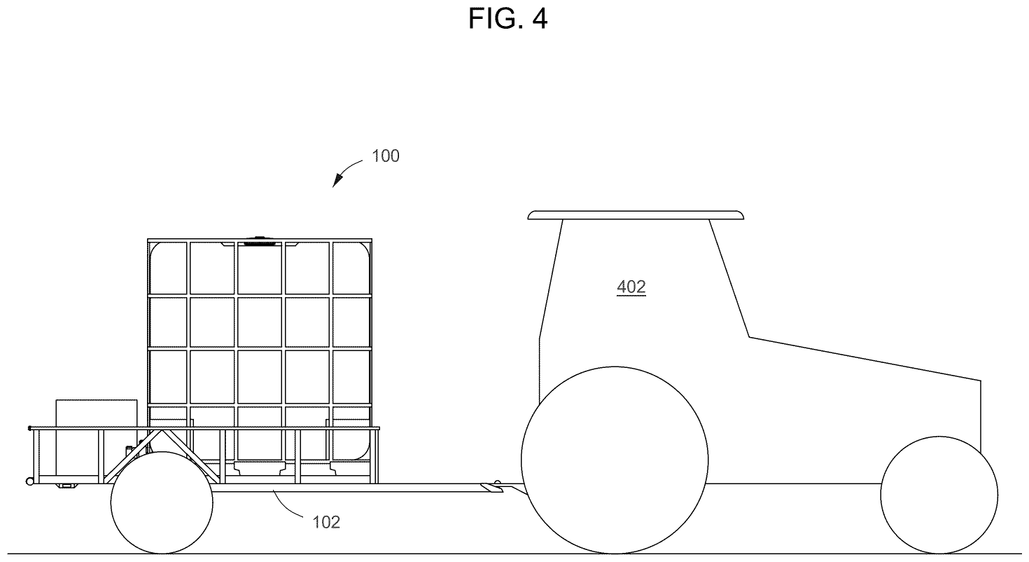

Referring to FIGS. 1A-B, an aggregate adhesive delivery assembly 100 includes a base 102, a vessel 104, a pump 106, a filter 116, and a boom 200. The vessel 104, the pump 106, and the boom 200 are disposed on the base 102. Preferably, the vessel 104, the pump 106, and the boom 200 are coupled to the base 102. The base 102 may be a flat metal plate. In some versions the base 102 may be a skid (see FIG. 3B) or a trailer (see FIG. 4).

The vessel 102 is disposed inside a cage 108. The cage 108 may protect the vessel 102. Moreover, the cage 108 may help the vessel 102 retain its shape, e.g., when filled with fluid. The vessel 102 includes a valve 110. The valve 110 may be a ball valve. The valve 110 includes a lever 112 for turning the valve 110 to an open or closed position.

The pump 106 is fluidly coupled to the valve 110 by an inlet hose 114a. A filter 116 is fluidly coupled to the inlet host 114a. Fluid from the vessel 102 may flow through the filter 116. The fluid may contain debris. Hence, the filter 116 may capture and prevent the debris from entering the pump 106. Additionally, the pump 106 is coupled to the boom 200 by an outlet hose 114b.

The boom 200 is coupled to the base 102 parallel to an upper surface of the base 102. In other words, the boom is positioned horizontally relative to the ground. The boom 200 may be disposed adjacent and/or in front of an edge of the base 102. Also, the length of the boom 200 is greater than the width of the base 102. Accordingly, a portion of the boom 200 extends away from the base 102.

In some cases, the length of the boom 200 may be less than or equal to the width of the base 102.

FIG. 2A illustrates an exploded view of a boom 200 where an outer conduit 202 and an inner conduit 204 of the boom 200 is depicted as see-through. FIG. 2B illustrates a cross-sectional view of a boom 200.

Referring to FIGS. 2A-B, a boom 200 includes the outer conduit 202, the inner conduit 204, a joint 206, a first cap 212a, and a second cap 212b. The joint 206, the first cap 212a, and the second cap 212b are cylindrical. The joint 206, the first cap 212a, and the second cap 212b have boreholes extending through each. Accordingly, the joint 206, the first cap 212a, and the second cap 212b are conduits, e.g., hollow. Fluid may flow through the joint 206, the first cap 212a, and the second cap 212b. In some versions, the joint 206 and the first cap 212a may be unitary. The first cap 212a and the second cap 212b each have a body. The body is hollow. A flange 210 extends radially outward from the body. The flange 210 has an inner diameter that is less than or equal to an inner diameter of the inner conduit 204. Additionally, the flange 210 has an outer diameter that is greater than an inner diameter of the outer conduit 204.

A portion of the body of the first cap 212a is disposed in a first end of the outer conduit 202. A portion of the body of the second cap 212b is disposed in a second end of the outer conduit 202. Accordingly, the caps 212a, 212b are concentric with the outer conduit 202. Outer surfaces of the caps 212a, 212b are abutted against respective inner surfaces of the outer conduit 202. Additionally, a flange 210 of the caps 212a, 212b is abutted against a respective end of the outer conduit 202.

The inner conduit 204 is disposed within the outer conduit 202. An outer diameter of the inner conduit 204 is less than an inner diameter of the outer conduit 202. Thus, the arrangement of the inner conduit 204 inside the outer conduit 202 forms an annular space. One or more spacers 208 may be disposed in the annular space. The one or more spacers 208 may be disposed between the inner conduit 204 and the outer conduit 202. The one or more spacers 208 may be abutted against an outer surface of the inner conduit 204. The one or more spacers 208 may be abutted against an inner surface of the outer conduit 202.

The inner conduit 204 has an outer diameter that is less than an inner diameter of the caps 212a, 212b. A portion of a first end of the inner conduit 204 is disposed in the first cap 212a. The first end of the inner conduit 204 extends through the first cap 212a. The first end of the inner conduit is coupled to the joint 206. Male threads (not shown) on an outer surface of the joint 206 may threadably coupled to female threads (not shown) on an inner surface of the inner joint 204. Accordingly, the inner conduit 204 is capable of receiving fluid that flows through the joint 206. A portion of a second end of the inner conduit 204 is disposed in the cap 212b. The second end of the inner conduit 204 extends through the second cap 212b. Inner surfaces of the caps 212a, 212b are abutted against respective inner surfaces of the outer conduit 202.

The caps 212a, 212b are concentric with the inner conduit 204. Thus, the caps 212a, 212b, the outer conduit 202, and the inner conduit 204 are concentric.

An end portion of the body of each cap 212 may be inserted into the respective ends of the outer conduit 202 such that an end of the outer conduit 202 is abutted against the respective flange 210. In other words, the end portion of the body of each cap 212 is disposed in the annulus between the outer conduit 202 and the inner conduit 204. Because an outer surface of the body of each cap 212 is abutted against an inner surface of the outer conduit 202 and an inner surface of the body of the each 212 is abutted against an outer surface of the inner conduit 204, the body may be sealingly coupled to respective ends of the outer conduit 202 and the inner conduit 204. Thus, the body of each cap 212 may inhibit fluid flow in the annulus between the outer conduit 202 and the inner conduit 204.

Fluid that is injected, e.g., by a pump, through the joint 206 and the first cap 212a would enter a first end of the inner conduit 204. Additionally, because the second cap 212b has a borehole disposed therethrough, fluid that is injected, e.g., by a pump, through the inner conduit 204 would pass through a second end of the inner conduit 204 and through the second cap 212b. Thus, a plug 214 is disposed in the second end of the inner conduit 204 to inhibit fluid flow out of the second end of the inner conduit 204. The plug 214 may be threadably coupled to the second cap 212b. An outer surface of the plug 214 is abutted against an inner surface of the inner conduit 202. Hence, the plug 214 is said to be “sealingly coupled” to the inner conduit 212b.

In some versions, the second cap 212b and the plug 214 may be unitary. In other versions, the second cap 212b has a body and a solid end. The body is disposed between the first conduit 202 and the second conduit 204. The solid end is abutted against a second end of the first conduit 202 and a second end of the second conduit 204. The solid end is capable of being sealingly coupled to respective second ends of the first conduit 202 and the second conduit 204. Accordingly, the second cap 212b is capable of inhibiting fluid flow out of the second end of the outer conduit 204 and out of the second end of the inner conduit 204.

The inner conduit 204 has an inner surface and an outer surface. One or more inner apertures 216a extend from the inner surface through to the outer surface. The one or more inner apertures 216a are aligned in a straight row and evenly spaced, e.g., approximately 0.325 inch apart from each other. Fluid injected into the inner conduit 204 may exit through the one or more inner apertures 216a. Preferably, the one or more inner apertures 216a are disposed in the upper portion, e.g., top, of the inner conduit 204 that is positioned horizontally. Thus, when fluid is injected into the inner conduit 204, the fluid would first fill the inner conduit 204 entirely and then exit through all inner apertures 216a uniformly, e.g., simultaneously. After the fluid exits the inner conduit 204, it would enter the outer conduit 102.

The outer conduit 202 has an inner surface and an outer surface. Outer apertures 216b extend from the inner surface through to the outer surface. The one or more outer apertures 216b are aligned in a straight row and evenly spaced, e.g., approximately 0.25 inch apart from each other. The one or more outer apertures 216b are disposed at the lower portion, e.g., bottom, of the outer conduit 102 that is positioned horizontally. Thus, fluid entering the outer conduit 202 would exit the one or more outer apertures 216b. Because the fluid from the inner conduit 204 would uniformly exit through all inner apertures 216a, that fluid would uniformly exit the one or more outer apertures 216b as well.

FIG. 3A illustrates a side view of an aggregate adhesive delivery assembly 100 configured for carriage by a skid-steer loader 302. FIG. 3B illustrates an overhead view of an aggregate adhesive delivery assembly 100 carried by a skid-steer loader 302.

Referring to FIGS. 3A-B, an aggregate adhesive delivery assembly 100 includes a base 102, a vessel 104, a pump 106, and a boom 200. The vessel 104, the pump 106, and the boom 200 are disposed on the base 102. Preferably, the vessel 104, the pump 106, and the boom 200 are coupled to the base 102. The base 102 of FIGS. 3A-B is a skid configured to receive forks of a skid-steer loader 302. Accordingly, the skid-steer loader 302 may be used to maneuver the aggregate adhesive delivery assembly 100 during operations to deliver adhesive onto aggregate 304.

FIG. 4 illustrates a side view of an aggregate adhesive delivery assembly 100 configured for hitching to a tractor 402. The aggregate adhesive delivery assembly 100 includes a base 102 that is a trailer. The trailer is configured for hitching to the tractor 402. Accordingly, the tractor 402 may be used to maneuver the aggregate adhesive delivery assembly 100 during operations to deliver adhesive onto aggregate.

It should be understood the trailer 102 could be hitched to other vehicles, e.g., trucks and all-terrain vehicles (ATV).

Referring to FIGS. 1A-B, 2A-B, and 3A-B, an aggregate adhesive delivery assembly 100 may be used to deliver adhesive onto aggregate. First, an operator may set an aggregate adhesive delivery assembly 100 on a skid-steer loader 302. The operator may maneuver the skid-steer loader 302 so that a portion of a boom 200 of the aggregate adhesive delivery assembly 100 is disposed over a bed of aggregate.

Afterwards, the operator may turn a valve 110 of a vessel 102 of the aggregate adhesive delivery assembly 100 to an open position. Fluid, e.g., adhesive, in the vessel may exit the valve 110. The exiting fluid may flow, via an inlet hose 114a, to a pump 106. Next, the operator may turn on the pump 106. The running pump 106 may eject the fluid, via an outlet hose 114b, into an inner conduit 204 of the boom 200. The fluid may fill the inner conduit entirely before exiting inner apertures 216a extending through the inner conduit 204. The one or more inner apertures 216a are disposed in the upper portion, e.g., top, of the inner conduit 204. Thus, the fluid in the inner conduit 204 may exit through all the inner apertures 216a uniformly, e.g. simultaneously.

After the fluid exits the inner conduit 204, it would enter the outer conduit 202. Because the fluid exits the one or more outer inner apertures 216a of the inner conduit 204 uniformly, it will flow to outer apertures 216b of the outer conduit 202 uniformly as well. In other words, each outer aperture 216b may receive an approximately similar quantity of fluid. Thus, fluid in the outer conduit 202 may exit the one or more outer apertures 216b uniformly, e.g., simultaneously. Accordingly, the fluid exiting the boom 200 may drip uniformly onto a portion of an aggregate bed 304 below the boom 200 evenly.

As the pump 106 runs, the operator may drive the skid-steer loader 302 along the length of the aggregate bed 304 to evenly spread fluid thereon. Fluid spread on the aggregate bed 304 would coat surfaces of aggregate and cure. The cured fluid may harden, thereby holding the aggregate together.

The assemblies and methods described herein of applying or introducing a fluid to the surfaces and interstices of an aggregate, preferably a resin fluid, and more preferably a resin fluid that can be cured after it falls in place in the aggregate, so that it takes on solid form, may include the use of a boom such as but not limited to the boom disclosed herein. Preferably the boom includes at least an inner conduit and an outer conduit with an annular space between the outer surface of the inner conduit and the inner surface of the outer conduit. In preferred embodiments, the inner conduit has apertures positioned in places along the upper side of the inner conduit, e.g., the upper semi-circular cylindrical surface of the inner conduit, so that fluid, e.g., resin fluid, can pass through those apertures, and into the upper portion of the annular space between the two conduits. As part of the methods disclosed herein, the resin enters the upper portion of the annular space from the inside of the inner conduit, exits the inner conduit through inner apertures, and then falls, e.g., flows, to the lower portion of the annular space due to pressure generated by a pump and/or gravity. Preferably, the outer conduit has apertures positioned in places along the lower side of the outer conduit, e.g., the lower semi-circular cylindrical surface of the outer conduit, so that fluid, e.g., resin fluid, can pass through those apertures, and onto the aggregate and into interstices of the aggregate.

It should be understood that an aggregate adhesive delivery assembly 100 may be disposed on a carriage, e.g., trailer, skid, or boom, for hitching to other vehicles, e.g., tractors, trucks, or all-terrain vehicles (ATV).

What is claimed as the invention is:

1. A method of delivering adhesive onto aggregate, comprising:
providing an aggregate adhesive delivery assembly that comprises:
a vessel;
a pump fluidly coupled to the vessel;
an inner conduit having one or more inner apertures extending therethrough; and
an outer conduit disposed around the inner conduit, the outer conduit having one or more outer apertures extending therethrough;
pumping, with the pump, fluid from the vessel into the inner conduit;
ejecting the fluid in the inner conduit through the one or more inner apertures into the outer conduit; and
causing the fluid in the outer conduit to exit the one or more outer apertures.

2. The method of claim 1, wherein the one or more inner apertures are aligned in a row.

3. The method of claim 1, wherein the one or more inner apertures are evenly spaced from each other.

4. The method of claim 1, wherein the one or more outer apertures are aligned in a row.

5. The method of claim 1, wherein the one or more outer apertures are evenly spaced from each other.

6. The method of claim 1, wherein the one or more inner apertures are aligned in a first row and the one or more outer apertures are aligned in a second row parallel to the first row.

7. The method of claim 1, wherein the one or more inner apertures are aligned in a first row and the one or more outer apertures are aligned in a second row directly below the first row.

8. The method of claim 1, wherein the aggregate adhesive delivery assembly further comprises a cap having a cap portion abutted against an outer surface of the inner conduit and an inner surface of the outer conduit.

9. The method of claim 1, wherein the aggregate adhesive delivery assembly further comprises a spacer disposed between the inner conduit and the outer conduit.

10. The method of claim 1, wherein the aggregate adhesive delivery assembly further comprises a cap having a portion capable of inhibiting fluid flow in an annulus that is between the inner conduit and the outer conduit.

11. The method of claim 1, further ejecting fluid in the inner conduit through the one or more inner apertures simultaneously.

12. The method of claim 1, further causing fluid in the outer conduit to exit through the one or more outer apertures simultaneously.

13. A method of delivering adhesive onto aggregate, comprising:
providing an aggregate adhesive delivery assembly that comprises:
a vessel;
a pump fluidly coupled to the vessel;
an inner conduit having one or more inner apertures extending through an upper portion of the inner conduit; and
an outer conduit disposed around the inner conduit, the outer conduit having one or more outer apertures extending through a lower portion of the outer conduit;
pumping, with the pump, fluid from the vessel into the inner conduit;
ejecting the fluid in the inner conduit through the one or more inner apertures into the outer conduit; and
causing the fluid in the outer conduit to exit the one or more outer apertures in a downwardly direction.

14. The method of claim 13, wherein the upper portion of the inner conduit has a semi-circular inner surface.

15. The method of claim 13, wherein the lower portion of the outer conduit has a semi-circular inner surface.

16. The method of claim 13, wherein fluid flowing through the one or more inner apertures flow in an upwardly direction.

17. The method of claim 13, wherein fluid flowing through the one or more inner apertures flow in a first direction and fluid flowing through the one or more outer apertures flow in a second direction that is opposite of the first direction.

18. A method of delivering adhesive onto aggregate, comprising:
providing an aggregate adhesive delivery assembly that comprises:
a vessel;
a pump fluidly coupled to the vessel;
an inner conduit having one or more inner apertures extending through a top portion of the inner conduit; and
an outer conduit disposed around the inner conduit, the outer conduit having one or more outer apertures extending through a bottom portion of the outer conduit;
pumping, with the pump, fluid from the vessel into the inner conduit;
ejecting the fluid in the inner conduit through the one or more inner apertures in an upwardly direction into the outer conduit; and
causing the fluid in the outer conduit to exit the one or more outer apertures in a downwardly direction.

19. The method of claim 18, wherein the aggregate adhesive delivery assembly further comprises a cap having a portion disposed within the outer conduit.

20. The method of claim 18, wherein the aggregate adhesive delivery assembly further comprises a cap having a portion of the first conduit disposed therein.
